(19) United States
(12) Patent Application Publication
(10) Pub. No.: US 2026/0298073 A1
(43) Pub. Date: Oct. 1, 2026

(54) System and Method for Non-Magnetic and Touchless Sucker Rod Inspection and Evaluation

(71) Applicant: TRC Services, Inc., The Woodlands, TX (US)

(72) Inventors: Rodrigo Ariel Ruiz, Tomball, TX (US); Michael Eric Johnson, The Woodlands, TX (US); Luke Haug, Midland, TX (US); Tony O'Neal, Midland, TX (US)

(21) Appl. No.: 19/560,800

(22) Filed: Mar. 9, 2026

Related U.S. Application Data
(60) Provisional application No. 63/781,103, filed on Mar. 31, 2025.

(51) Int. Cl. E21B 47/009; G01S 7/481; G01S 17/48; G01S 17/89

(52) U.S. Cl. CPC E21B 47/009; G01S 7/4817; G01S 17/48; G01S 17/89

(57) ABSTRACT

Sucker rod components are inspected by scanning surfaces of the sucker rod component using one or more emitters and one or more detectors in a scan. A processing unit generates a geometric profile of the surfaces of the sucker rod components based on the scan, and the processing unit determines if there is any discontinuity between the geometric profile and a stored surface profile defining the expected shape, dimension, counter, etc. The processing unit measures parameters associated with the discontinuity and compares the geometric parameters to geometric limits, which define any tolerance, range, etc. that would fail inspection. The sucker rod component can then be rejected and accepted based on the comparison.

### CROSS-REFERENCE TO RELATED APPLICATIONS

This application claims the benefit of U.S. Provisional Appl. No. 63/781,103 filed Mar. 31, 2025, which is incorporated herein by reference in its entirety.

### BACKGROUND OF THE DISCLOSURE

In the oil field industry, many wells use a downhole reciprocating production pump to lift oil from a borehole to the surface. Sucker rods extend from the surface to the extraction area to enable a pump jack located at the surface to cause reciprocal movement of the rod and bring oil to the surface. These rods are known as sucker rods or pump rods. A sucker rod is a rigid rod that is typically between 25 and 40 feet in length and is threaded at both ends. The sucker rod is typically made of steel and can have a diameter from ⅝ inch to more than 1 or 1 ¼ inches. Sometimes the sucker rods are made of fiberglass with metal end fittings and are typically 37.5 feet in length.

For example, FIG. 1 shows a reciprocating pump system 10 used to produce fluid from a wellbore. A downhole pump 14 has a pump barrel 16 with a standing valve 17 located at the bottom. The standing valve 17 allows fluid to enter from the wellbore but does not allow the fluid to leave. Inside the pump barrel 16, a plunger 18 has a traveling valve 19, which allows fluid to move from below the plunger 18 to the production tubing 12 above but does not allow fluid to return from the production tubing 12 to the pump barrel 16 below the plunger 18. A driving source (e.g., a pump jack or pumping unit 11) at the surface connects by a rod string 15 to the plunger 18 and moves the plunger 18 up and down cyclically in upstrokes and downstrokes to lift fluid to the surface.

The rod string 15 is comprised of a plurality of sucker rod components 20. As shown specifically in FIG. 1, the rod string 15 is comprised of multiple sucker rods 30 connected end-to-end by couplings 40. The sucker rods 30 and the couplings 40 have standards for their design, manufacture, and assembly from the American Petroleum Institute (API).

A steel sucker rod 30 as shown in FIG. 2A typically includes a steel rod body 32 having rod ends 33 that are upset and forged onto the sucker rod 30. After forging, the sucker rod 30 is heat treated, and thread rollers are utilized to thread the pins 38 on the rod ends 33 of the sucker rod 30. The coupling 40 threads to the threaded pins 38 and is used to connect the sucker rods 30 end-to-end.

This manufacturing process of forging and heat treating, however, is susceptible to forging errors and the introduction of defects, such as micro-fractures, in the rod ends 33, particularly at the upsets 34 where the rod ends 33 join to the steel rod body 32. Furthermore, after the forging process, the steel sucker rod 30 must be heat treated in an effort to reduce residual stress and other potential defects and/or stress concentrators that may be introduced into the steel rod body 32 and/or the rod end 33 during the forging process. Heat treating adds both time and expense to the manufacture of sucker rods.

In addition to the steel sucker rods 30, other sucker rod component 20 can be used for the rod string 15 in FIG. 1, including a composite sucker rod. As shown in FIG. 2B, a composite sucker rod 30′ includes a composite rod body 32′ having ends 37 on which end fitting 33′ attach. The composite sucker rod 30′ can be composed of fiberglass or the like, and the end fitting 33′ can be composed of steel. The end fittings 33′ have sockets 39 that that affix with adhesive to the ends 37 of the rod body 32'. The end fittings 33′ have flats 35, a shoulder 36, and threaded pin 38 similar to a forged end piece.

In addition to the steel sucker rods 30 and the composite sucker rods 30', other sucker rod components 20 can be used on the rod string 15 in FIG. 1, including a sucker rod guide. As shown in FIG. 2C, a sucker rod guide 50 includes a body 52 that fits onto the sucker rod 30. Vanes 54 extend from the guide's body 52 to help center the sucker rod 30 when moving inside producing tubing (not shown). The sucker rod guide 50 can be made of a polymeric material, a thermoplastic elastomer, a thermoset resin, a polyurethane, a polyamide, a composite material, a metallic material, or another suitable material to withstand the environmental and operational conditions in which the sucker rod guide 50 is used. The sucker rod guide 50 is a molded or formed component that fits onto the sucker rod 30 and can be constrained primarily by an interference fit.

The sucker rod guide 50 may be molded onto the sucker rod 30 or may be fitted with an axial slot for installation on the sucker rod 30 in the field. The sucker rod guide 50 may be retrofitted onto or used with the sucker rod 30. Alternatively, the sucker rod guide 50 may be used on a dedicated rod or rod section, which may be as long as or shorter than a conventional sucker rod 30.

The vanes 54 on the sucker rod guide 50 extend in the annular space between the sucker rod 30 and surrounding production tubing. As the sucker rod 30 is reciprocated, the sucker rod guide 50 can act as a circumferential bushing and centralizer that centers the sucker rod 30 in the production tubing. The sucker rod guide 50 serves as a sacrificial component for riding along the production tubing and preventing metal-to-metal contact of the sucker rods 30 and couplings 40 against the production tubing.

For various reasons, such as wear and tear, the sucker rods must be removed and replaced from time to time. Typically, upon removal, the metal sucker rod is subjected to various forms of inspection, reconditioning and or remanufacturing. In this manner, a used metal sucker rod can be safely returned to service.

Typically the main process of reclaiming or reconditioning a used sucker rod utilized in oil pump wells comprises obtaining the sucker rod, cleaning the sucker rod to remove contaminates from use in oil extraction, performing a visual inspection of the rod body, the end fitting, gauging of the end fitting, and gauging the end threads after thread coupling has been removed to determine if the sucker rod should be reconditioned.

Sucker rods returned from field service (and even those sucker rods manufactured in a facility) can have surface impurities on them. The severity and kind of impurities presented on sucker rods can vary tremendously depending on the process used to manufacture the rod or depending on the field application for which the rod has been used.

Therefore, sucker rods are inspected to identify any superficial discontinuities, imperfections, and loss of cross-sectional area. Sucker rods are subjected to fatigue risks due to cyclic loading, and any discontinuities on the surface can act as a stress riser, potentially initiating a crack that evolves into failure.

For this inspection process, the industry relies on various techniques, including visual inspection, magnetic flux leakage (MFL), eddy current, and dry and wet magnetic particle inspection (WMP). Sucker rod manufacturing specifications require high accuracy, specifying a minimum detectable defect size of 0.004 inches for transverse discontinuities, 0.020 inches for longitudinal discontinuities, and a maximum depth of 0.008 inches for pits. Sucker rod installations use multiple sucker rods, and large volumes of rods need to be inspected when the rods are manufactured, refurbished, and reused. Using manual metrology tools to inspect the volume of rods processed daily is cost prohibitive.

For steel sucker rods, magnetic flux leakage (MFL) and dry and wet magnetic particle inspection (WMP) are the primary non-destructive testing (NDT) methods used. Magnetic flux leakage (MFL) involves inducing a magnetic field in the steel (using either an electromagnet or a permanent magnet) and using sensors to detect disruptions in the magnetic field caused by defects like cracks or corrosion. These disruptions or “leaks” in the magnetic flux are captured by the sensors, allowing for flaws to be identified without damaging the material. Dry and wet magnetic particle inspection also uses an induced magnetic field in the ferromagnetic material of the sucker rods and employs magnetic particles suspended in a liquid to detect defects.

Among these methods, magnetic flux leakage (MFL) is the fastest, capable of inspecting at speeds of 60-80 ft/min when properly calibrated, making it suitable for inspecting the cylindrical body of the sucker rod. However, the non-uniform geometry of the ends (e.g., forged ends and threaded pin ends) requires the use of dry and wet magnetic particle (WMP) inspection.

Several limitations are associated with these techniques. Both require magnetization and demagnetization steps. Both methods are limited in defining the depth and overall geometry of defects. They are sensitive to the cleanliness of the part. Magnetic flux leakage (MFL) inspection requires regular calibration to maintain accuracy. Additionally, magnetic flux leakage (MFL) inspection requires sensors to be in contact with the rod, leading to wear and tear on sensor components (“shoes”). Wet magnetic particle (WMP) inspection must be used to inspect non-uniform parts, such as the sucker rod ends.

For pultruded composite sucker rods, the only inspection method currently employed for the rod body is visual inspection by trained personnel. For steel end fittings, wet magnetic particle (WMP) inspection is used to evaluate for any discontinuities. The limitations for inspecting composite sucker rods are significant. Without a reliable method for inspecting the rod body, the process heavily depends on the training and visual evaluation performed by trained personnel so that the process is prone to inconsistency. Wet magnetic particle (WMP) inspection faces the same limitations as in the case of steel sucker rods, further underscoring the need for more effective inspection solutions.

In addition to inspecting the integrity of composite or steel sucker rods, the condition of the sucker rod guides attached to the rod body also require inspection. These guides, typically made of thermoplastic or thermoset polymers, are designed to prevent premature wear on both the sucker rod and the production tubing during operation. Acting as sacrificial components, the guides take on the wear that would otherwise damage critical equipment. If the guides become completely worn, they lose their protective function, exposing the rod and tubing to an increased risk of damage.

Evaluating the wear patterns of these guides provides valuable insights into the operating conditions of the well, helping users diagnose issues such as misalignment, high friction, or abrasive production fluids. This assessment also determines whether the guide has exceeded its intended service life, indicating the need for replacement to maintain the integrity and efficiency of the rod-pumping system.

What is needed is a high-speed, accurate inspection technique to evaluate the conditions of sucker rod guides and sucker rods, including both composite and steel sucker rods, their rod bodies, and their rod ends.

The subject matter of the present disclosure is directed to overcoming, or at least reducing the effects of, one or more of the problems set forth above.

### SUMMARY OF THE DISCLOSURE

As disclosed herein, a method is used on a plurality of sucker rods. Each sucker rod has a sucker rod component to be inspected. In the method, a surface profile associated with the sucker rod component is stored in memory, and a geometric limit associated with the sucker rod component is stored in memory. For the sucker rod component to be inspected on each of the sucker rods, a surface of the sucker rod component is scanned in a scan using at least one emitter and at least one detector. At least one processor generates a geometric profile of the surface of the sucker rod component based on the scan and determines any discontinuity between the geometric profile and the surface profile stored in the memory. The at least one processor measures a geometric parameter associated with the discontinuity and compares the geometric parameter in a comparison to the geometric limit. The at least one processor generates a recommendation of the sucker rod component based on the comparison. For example, the at least one processor can output at least one of a quality, a rejection, and an acceptance of the sucker rod component.

According to the present disclosure, a method is used on a plurality of sucker rods. Each sucker rod has a plurality of sucker rod components to be inspected. In the method, memory stores surface profiles that are each associated with a respective one of the sucker rod components, and the memory stores geometric limits that are each associated with a respective one the sucker rod components. For each given one of the sucker rod components of the plurality of sucker rod components to be inspected on each given one of the sucker rods, a surface of the given sucker rod component is scanned in a scan using at least one emitter and at least one detector. At least one processor generates a geometric profile of the surface of the given sucker rod component based on the scan and determines any discontinuity between the geometric profile and the surface profile associated with the given sucker rod component. The at least one processor measures a geometric parameter associated with the discontinuity and compares the geometric parameter in a comparison to the geometric limit associated with the given sucker rod component. The at least one processor generates a recommendation (e.g., at least one of a rejection and an acceptance) of the given sucker rod component based on the comparison. For each given sucker rod, the at least one processor can further generate a comprehensive assembly of the given sucker rod based on the assessments for each of the given sucker rod components of the given sucker rod.

According to the present disclosure, a system is used on a plurality of sucker rods. Each sucker rod has a given sucker rod component to be inspected. The system comprises memory, at least one emitter, at least one detector, and at least one processor. The memory stores a surface profile associated with the giver sucker rod component and stores a geometric limit associated with the given sucker rod component. The at least one emitter is configured to emit electromagnetic radiation onto a surface of the given sucker rod component of the sucker rods, and the at least one detector is configured to detect signals after interaction of the emitted electromagnetic radiation with the surface of the given sucker rod component.

The at least one processor is in operable communication with the memory, the at least one emitter, and the at least one detector. For the given sucker rod component to be inspected on each of the sucker rods, the at least one processor is configured to scan the surface of the given sucker rod component in a scan using the at least one emitter and the at least one detector. The at least one processor generates a geometric profile of the surface of the given sucker rod component based on the scan and determines any discontinuity between the geometric profile and the surface profile. The at least one processor measures a geometric parameter associated with the discontinuity and compares the geometric parameter in a comparison to the geometric limit. The at least one processor generates an assessment (e.g., at least one of a quality, a rejection, and an acceptance) of the sucker rod component based on the comparison. The system can also scan and assess multiple sucker rod components on each of the sucker rods.

The foregoing summary is not intended to summarize each potential embodiment or every aspect of the present disclosure.

### BRIEF DESCRIPTION OF DRAWINGS

FIG. 1 illustrates a reciprocating rod pump system according to the prior art.

FIG. 2A illustrates an elevational view of forged sucker rod ends according to the prior art for connecting together with a coupling.

FIG. 2B illustrates an elevational view of a composite sucker rod with adhesive-attached end fittings according to the prior art.

FIG. 2C illustrates an elevational view of a sucker rod guide according to the prior art for use on a sucker rod.

FIG. 3 schematically illustrates components of an inspection system according to the present disclosure.

FIGS. 4A-4D schematically illustrate geometric profiles of a sucker rod component obtained with the inspection system.

FIG. 5 schematically illustrates additional components of the inspection system according to the present disclosure.

FIGS. 6A-6C schematically illustrate configurations for a handling unit of the inspection system.

FIGS. 7A-7C schematically illustrate arrangements for scanning units of the inspection system.

FIG. 8 schematically illustrates components of a processing unit 110 according to the present disclosure.

FIG. 9 illustrates a scanning inspection process according to the present disclosure.

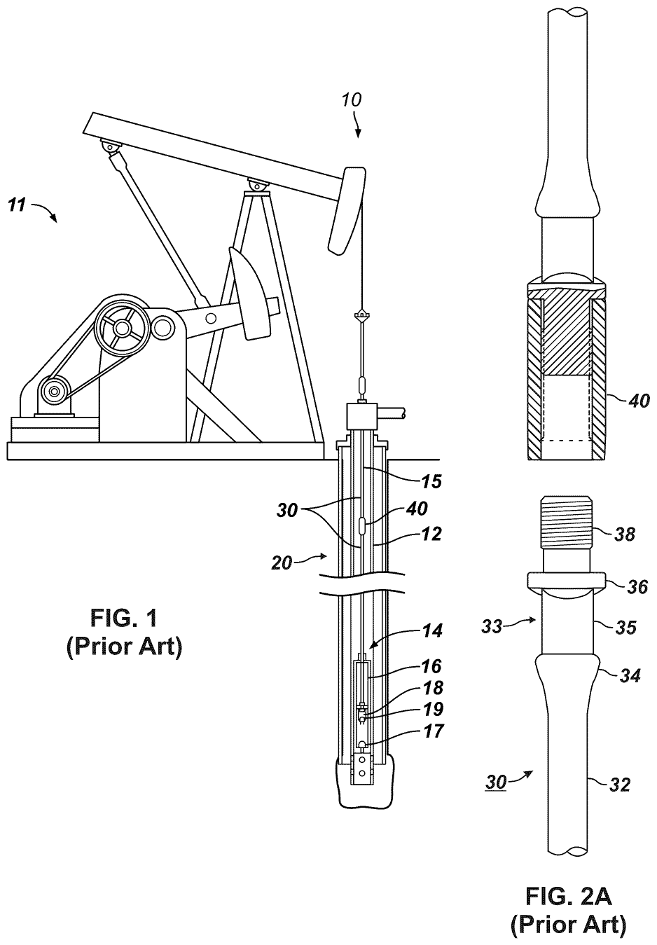

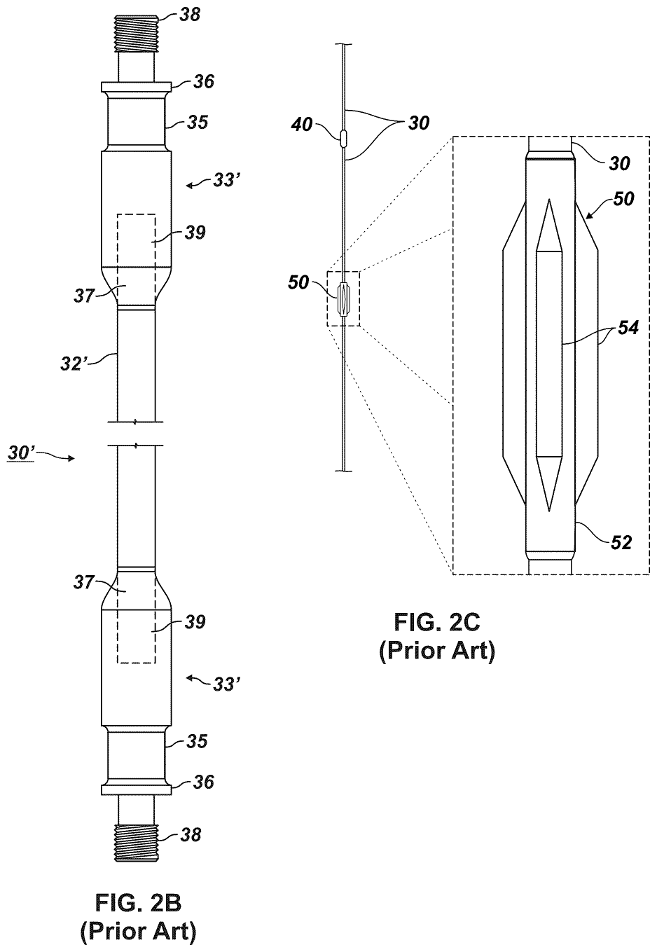

### DETAILED DESCRIPTION OF THE DISCLOSURE

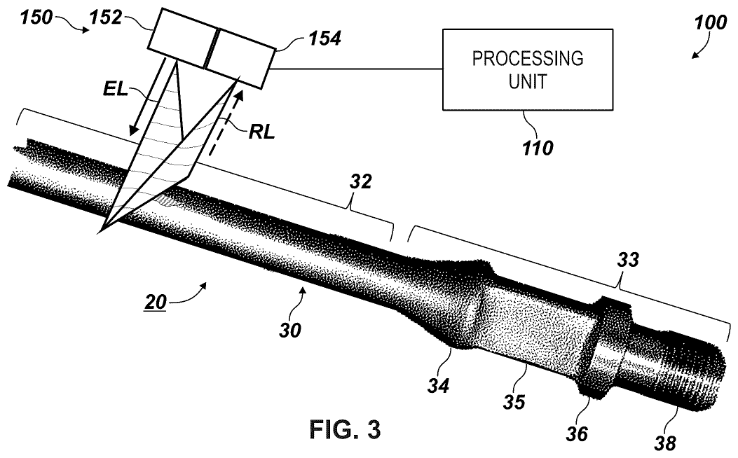

FIG. 3 schematically illustrates an inspection system 100 according to the present disclosure. The inspection system 100 of the present disclosure is directed to non-destructive inspection of sucker rod components 20, such as different parts of sucker rods, to the guides used on sucker rods, and the like. The inspection system 100 has at least one emitter 152 to emit electromagnetic radiation at the sucker rod components 20 and has at least one detector 154 to detect signals of the electromagnetic radiation after interaction with the sucker rod components 20.

The inspection system 100 can inspect the sucker rod components 20 when the sucker rods are assembled. For example, the sucker rods can be new sucker rods to be inspected after manufacturing and assembly. Also, the inspection system 100 can inspect used sucker rods to be reused after cleaning, refurbishing, and inspection. Additionally, the sucker rods can have one sucker rod component 20 to be inspected or can have multiple sucker rod components 20 to be inspected together. Moreover, during initial manufacturing or reuse, the inspection system 100 can inspect individual sucker rod components 20 before assemblage as a sucker rod.

As shown, the inspection system 100 includes a processing unit 110 and one or more scanning units 150—one of which is shown. The scanning unit 150 includes an emitter 152 and a detector 154, which can be appropriately positioned relative to one another and a sucker rod component 20 to be scanned. Although the emitter 152 and the detector 154 may be used in the scanning unit 150 as a pair, this is not strictly necessary. The emitter 152 may be movable separately from the detector 154 depending on the type of scanning performed. Moreover, one detector 154, such as a camera, may be capable of capturing images associated with multiple emitters 152, and one emitter 152 may be capable of emitting electromagnetic radiation for multiple detectors 154.

As shown here, the sucker rod component 20 is a metal sucker rod 30 having a rod body 32 and a forged rod end 33. The forged rod end 33 connects by a forged upset 34 to the rod body 32 and includes flats 35, a shoulder 36, and a threaded pin 38.

Before inspection, the sucker rod component 20 is cleaned to remove any debris, dirt, and the like that would interfere with a scan of the component's surfaces. The emitter 152 emits electromagnetic radiation EL (e.g., light in the form of a laser line, a coded pattern of structured light, a spot, etc.) onto surfaces of the sucker rod component 20 (e.g., sucker rod 30, guide, rod body 32, rod end 33, etc.). The detector 154 detects electromagnetic radiation RL after interaction with the surface of the sucker rod component 20.

In general, the detectors 154 can detect reflected, scattered, absorbed, or re-emitted signals of the emitted electromagnetic radiation incident on the surfaces of the sucker rod components 20. For most purposes disclosed herein, the emitted electromagnetic radiation incident on the surfaces is reflected form the surfaces as reflected electromagnetic radiation RL for detection by the detector 154. In general, the wavelength of the emitted electromagnetic radiation from the emitter 152 can be in the visible, near-infrared (NIR), infrared (IR), or ultraviolet (UV) wavelength spectrums, and the detector 154 can be configured to detect the appropriate wavelengths reflected from the surfaces of the sucker rod components 20. However, wavelengths of the electromagnetic radiation can be selected depending on the characteristics of the surface and the underlying material of the sucker rod component, such as steel, composite, fiberglass, thermoplastic, etc.

The inspection system 100 creates a detailed surface profile of the surfaces, and automated detection using this surface profile can then detect defects, including cracks, pits, discontinuities, and cross-sectional area loss, on the sucker rod component 20 without the need for magnetization, calibration, or physical contact with the sucker rod component 20. The inspection system 100 can evaluate both steel and composite sucker rods 30 with equal accuracy and can inspect complex geometries, such as forged rod ends 33, threaded pins 38, and sucker rod guides (not shown), making the inspection system 100 a versatile and comprehensive inspection tool.

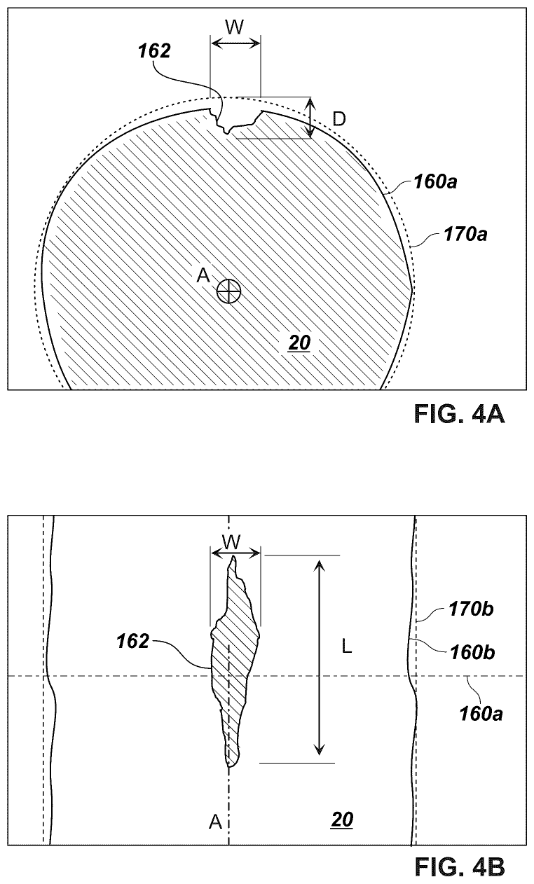

FIGS. 4A-4D schematically illustrate geometric profiles 160a, 160b of a portion of a sucker rod component 20 (i.e., a rod body of a sucker rod) obtained with the inspection system 100. The geometric profile 160a in FIG. 4A is a wafer or slice from the scan, showing a cross-section perpendicular to the axis A the sucker rod component 20 (i.e., rod body), while the geometric profile 160b in FIG. 4B is an elevational view of the sucker rod component 20 (i.e., rod body). In a similar fashion, the geometric profile 160a in FIG. 4C is again the wafer or slice from the scan, showing the cross-section perpendicular to the axis A of the sucker rod component 20 (i.e., rod body), while the geometric profile 160c in FIG. 4D is cross-sectional view along the axis A of the sucker rod component 20 (i.e., rod body).

The system's processing unit (110) constructs the geometric profiles 160a-b form data obtained in the scanning. The system's processing unit (110) accesses surface profiles 170a-b stored in memory for the sucker rod component 20 being investigated and then determines any discontinuity 162 between the generated geometric profile 160a-b produced by the scan and the expected surface profile 170a-b for the subject sucker rod component 20. The discontinuity 162 can be a defect, a crack, a microcrack, a pit, a cross-sectional area loss, wear, a chip in coating, a dimensional variation, etc. The processing unit (110) can measure one or more geometric parameters associated with the discontinuity 162. For example, the geometric parameters can include the dimensions of the discontinuity 162, such as a length L, a depth D, a width W, an area, a volume, etc. of the discontinuity 162 relative to the expected surface profile 170a-b. The processing unit (110) compares the geometric parameters to geometric limits associated with the sucker rod component 20 and generates an assessment of the sucker rod component 20 based on the comparison. For example, if any of the geometric parameters for the discontinuity 162 exceed the geometric limit, the processing unit (110) can reject the sucker rod component 20 being inspected (and the entire sucker rod if that is the case). Otherwise, the processing unit (110) can accept the sucker rod component 20 being inspected. Acceptance of the entire sucker rod can depend on acceptance of each of the different sucker rod components being inspected.

The inspection system 100 in FIG. 3 overcomes the limitations of traditional sucker rod inspection methods like visual inspection, Wet Magnetic Particle (WMP) inspection, and Magnetic Flux Leakage (MFL) inspection. The inspection system 100 can assess all parts of the sucker rod components 20 and all sucker rod components 20 of a sucker rod. For the sucker rod 30, for example, the inspection system 100 can access the rod body 32, the rod ends 33, the forged upset 34, the flat 35, the shoulder 36, the threaded pin 38, etc. The inspection system 100 can also assess other sucker rod components 20, such as composite sucker rods and sucker rod guides. For instance, the inspection system 100 can inspect for discontinuities (e.g., a defect, a crack, a microcrack, a pit, a cross-sectional area loss, wear, a chip in coating, a dimensional variation, etc.) in both steel and composite materials, such as a fiberglass rod body of the sucker rod, a steel rod body and forged rod ends of the sucker rod, etc.

Additionally, for instance, the inspection system 100 can inspect for discontinuities (e.g., a defect, a crack, a microcrack, a pit, a cross-sectional area loss, wear, a chip in coating, a dimensional variation, etc.) in sucker rod guides 50 composed of thermoplastic. As is known, sucker rod guides 50 can prevent wear on sucker rods 30 and production tubing. The inspection system 100 can be used to inspect a sucker rod guide for wear patterns, geometry, and surface conditions. The inspection system 100 can detect microcracks and can measure material loss on the polymeric sections of the sucker rod guide 50, providing essential data to determine if the sucker rod guide 50 has surpassed its intended service life.

The inspection system 100 can also inspect for any discontinuities in a coating on a sucker rod component 20. Various types of coatings may be used on sucker rod components 20 to withstand the harsh environment downhole. For example, coatings can be used on sucker rods 30 to inhibit corrosion or to protect against wear. The scanning performed by the inspection system 100 can find discontinuities, such as areas where the coating is missing, worn, chipped, or the like.

For each of these sucker rod components 20, the detailed data generated by the inspection system 100 provides insights into defect trends and root causes, enabling proactive improvements in manufacturing and field operations. This feature addresses a significant gap in current inspection methods, as traditional techniques cannot reliably evaluate sucker rod components, such as steel sucker rods, composite or fiberglass sucker rod bodies, forged rod ends, metal end fittings, polymeric components like sucker rod guides, etc.

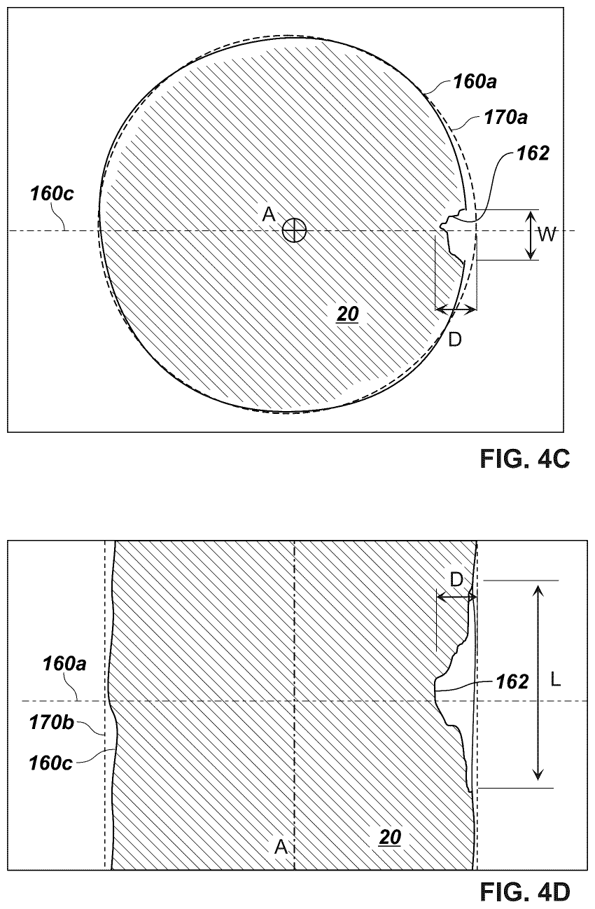

FIG. 5 schematically illustrates additional components of the inspection system 100 according to the present disclosure. Again, the inspection system 100 includes a processing unit 110 and scanning units 150, several of which are shown. Each of the scanning units 150 includes an emitter 152 and a detector 154, which can be appropriately positioned relative to one another and the sucker rod component(s) 20 to be scanned. As shown here, the sucker rod components 20 can be part of an assembled sucker rod 30, such as a metal sucker rod, having a rod body 32 and a forged rod end 33 and having a sucker rod guide 50 disposed on the rod body 32.

The inspection system 100 also includes a handling unit 130 that can handle the sucker rod components 20. The handling unit 130, which can include a conveyor, can move the sucker rod components 20 relative to the scanning units 150 so surfaces of the sucker rod components 20 can be scanned and evaluated. The scanning units 150 may also be moved relative to the sucker rod components 20 to scan the surfaces. Alternatively, only the scanning units 150 may be moved relative to the sucker rod components 20, which can remain stationary on the handling unit 130.

Because the inspection system 100 does not need to contact the sucker rod components 20 being inspected, there are no issues with any wear and tear associated with physical inspection tools, reducing maintenance costs and improving system longevity. Additionally, the inspection system 100 can have high-speed, automated operation, which streamlines the inspection process and enables manufacturers, refurbishes, and operators to process large volumes of sucker rods 30 and other components 20 efficiently while maintaining consistent accuracy. The inspection system 100 generates comprehensive, actionable information on both the sucker rod 30, the sucker rod guide 50, and other sucker rod components 20 to evaluate the components'reliability. The information can also provide valuable insights into well conditions and operational trends. Ultimately, this inspection system 100 enhances the performance, safety, and cost-effectiveness of sucker rod operations, making it an indispensable tool in modern oilfield maintenance and manufacturing.

The inspection system 100 provides comprehensive inspection, eliminating the need for multiple inspection techniques (e.g., MFL for rod bodies and WMP for rod ends) by providing a single, integrated method that inspects the entire sucker rod component 20, including complex geometries, in one pass. Although the inspection system 100 provides this comprehensive inspection using the scanning process detailed herein, the inspection system 100 can be used in conjunction with other inspection tools 140, based on magnetic flux leakage (MFL) inspection, eddy current, wet magnetic particle (WMP) inspection, etc. All the same, compared to these techniques, the scanning process of the inspection system 100 provides high accuracy to detect smaller defects, to measure depth and geometry more precisely, and to provide quantifiable data that exceeds the capabilities of traditional methods. Unlike MFL and WMP, the inspection system 100 does not require physical contact, reducing wear and tear on components and lowering maintenance costs. Moreover, the scanning process of the inspection system 100 provides a direct measurement of discontinuities (e.g., defects). In contrast, the magnetic flux leakage (MFL) inspection measures magnetic flux leakage that must be paired with a manual measurement with a calibrated tool so the leakage signal can be correlated to a depth of the defect. The scanning process disclosed herein can obtain a direct readout of the defect.

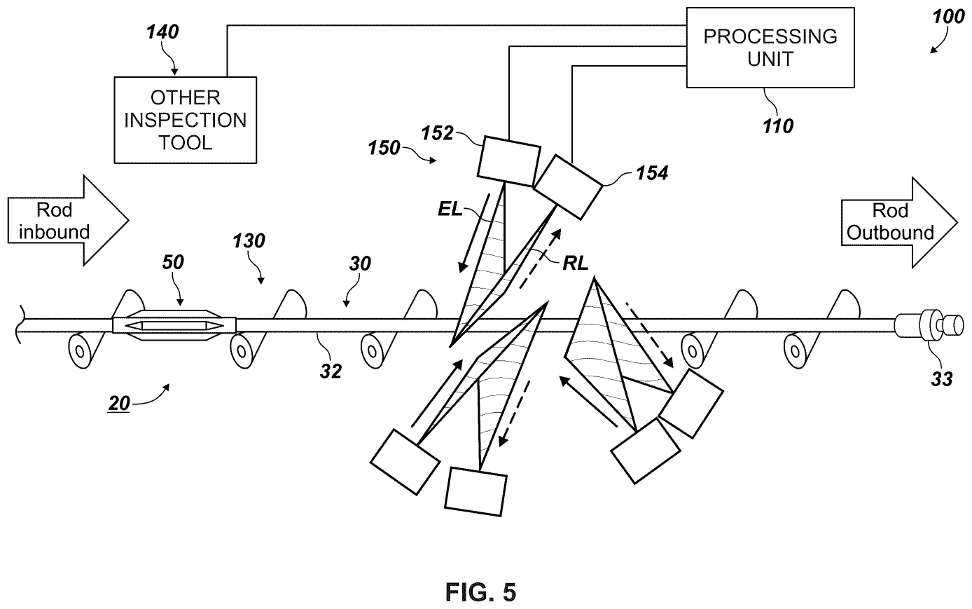

As noted above, the inspection system 100 can use a handling unit 130, which can be a motorized mechanism and can have motorized rollers, grippers, conveyor, or the like. FIGS. 6A-6C schematically illustrate components of a few examples for a handling unit 130 that can be used to handle/move the sucker rod components 20. In FIG. 6A, the handling unit 130 includes a plurality of rollers. At least some of the rollers can be motorized rollers 132 while others may be idler rollers 134. The motorized rollers 132 can control the direction and speed at which the sucker rod component 20 is moved through a machine's chamber, an enclosure, or another controlled environment relative to the one or more scanning units 150, which can be positioned at one or more locations. The scanning units 150 can operate while the handling unit 130 moves sucker rod component 20. In addition to or as an alternative to moving the sucker rod component 20 during scanning, the scanning units 150 can be moved relative to the sucker rod component 20 (i.e., closer and further perpendicularly relative to the sucker rod component 20 and/or parallel relative to the sucker rod component 20). Therefore, the sucker rod component 20 can only be moved, only the scanning units 150 may be moved, or a combination of these techniques can be used.

In FIG. 6B, the handling unit 130 includes motorized grippers 136 and a plurality of rollers 134 that can be used to move the sucker rod 30. The motorized gripper 136 can use a pair of pinch rollers that grip opposite sides of the sucker rod component 20 (e.g., sucker rod) to control its movement. The pinch rollers of the grippers 136 can have grooves (e.g., V-grooves) to accommodate the cylindrical shape of the sucker rod. The motorized grippers 136 can push/pull the sucker rod component 20, and the orientation of the grippers 136 can be turned to rotate the sucker rod component 20 about its longitudinal axis relative to the scanning units 150.

In FIG. 6C, the handling unit 130 includes a conveyor 138 to move the sucker rod component 20. The conveyor 138 can use chain-driven rollers to move the sucker rod component 20. Alternatively, as shown here, the conveyor 138 can be a flat belt conveyor having a belt surface for moving the sucker rod component 20 along a flat path.

In each of these examples, the handling unit 130 can include rail guides, centering blocks, and the like (not shown) to keep the sucker rod component 20 aligned and to prevent bending or sagging. The motorized mechanism of the handling unit 130 can move the sucker rod component 20 longitudinally in one direction from one end to the other relative to the scanning units 150. The speed (i.e., length per unit time) at which the sucker rod component 20 is moved can be a controllable variable set by the processing unit 110. For example, the handling unit 130 can handle the sucker rod component 20 at a slower pace at the ends to address defects in the more complex geometries of the forged ends or the end fitting (in the case of fiberglass rods). The handline unit 130 can use a faster pace when running the nominal diameter section of the sucker rod component 20. Additionally, the motorized mechanism of the handling unit 130 may be able to stop the movement of the sucker rod component 20 to expose its surfaces to the scanning units 150. Moreover, the motorized mechanism of the handling unit 130 may be able to operate in opposing directions to move the sucker rod component 20 longitudinally back and forth relative to the scanning units 150.

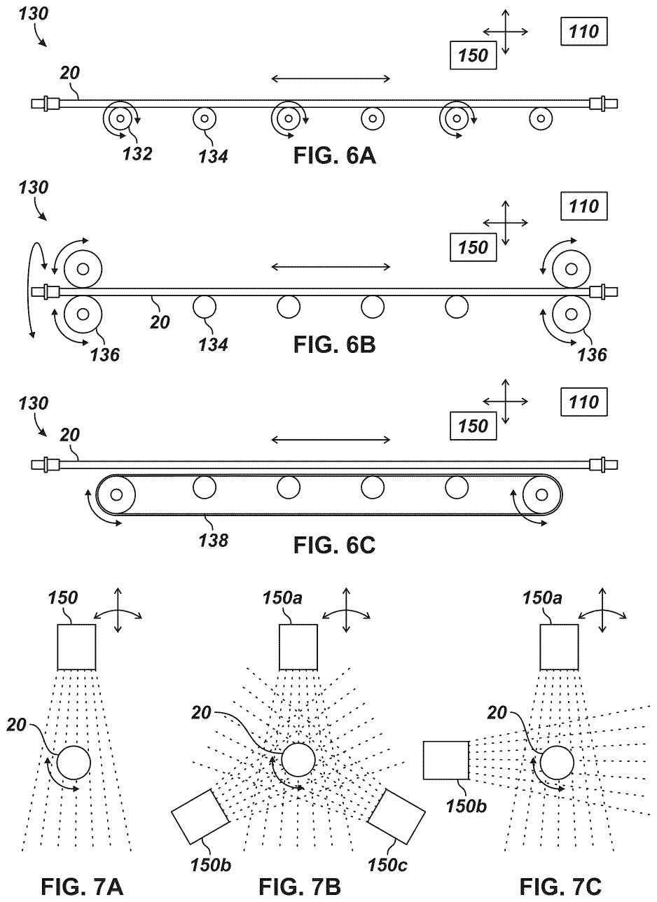

In any of the arrangements, the scanning units 150 can be arranged in one or more directions, such as noted previously and as shown in FIG. 5. For example, FIG. 7A schematically illustrates an end view of a sucker rod component 20 (e.g., cylindrical rod body) relative to a scanning unit 150 directed at the sucker rod 30 to perform the scanning. The handling unit 130 can rotate the sucker rod component 20 relative to the scanning unit 150 to increase coverage of the subject scanning. Additionally or alternatively, the scanning unit 150 may be moved relative to the sucker rod component 20.

As schematically shown in FIG. 7B, more than one scanning unit 150a-c at different orientations can be directed at the sucker rod component 20 to increase coverage of the subject scanning. Here, three scanning units 150a-c are arranged at 120 degrees about the sucker rod component 20, but more or fewer scanning units 150a-c can be used and can be arranged at any number of acceptable orientations. The handling unit 130 may or may not rotate the sucker rod component 20, and the scanning units 150 (or individual emitters 152 and detectors 154) may or may not be moved relative to the sucker rod component 20.

Additionally, FIG. 7C shows how multiple scanning units 150a-b can be used in conjunction with rotation of the sucker rod component 20 to increase coverage for the subject scanning. The scanning units 150 may or may not be moved relative to the sucker rod component 20.

As will be evident from FIGS. 6A through 7C, movement of the sucker rod component 20 and the one or more scanning units 150 relative to one another can involve at least one of: moving the sucker rod component 20 relative to the one or more scanning units 150; moving the one or more scanning units 150 relative to the sucker rod component 20 (e.g., parallel to the sucker rod component 20 or toward and away from the sucker rod component 20); moving the sucker rod component 20 in an axial direction; rotating the sucker rod component 20 about an axis; moving the one or more scanning units 150 in the axial direction; and rotating the one or more scanning units 150 about the axis.

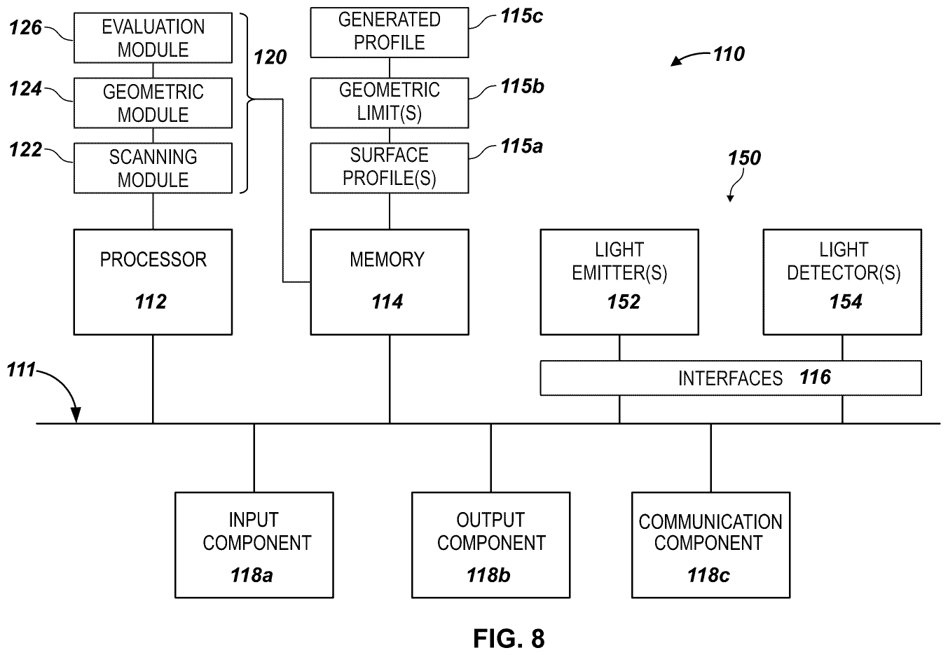

FIG. 8 schematically illustrates components of a processing unit 110 (e.g., central PLC control system, processing device, control unit, etc.), which can correspond to the processing unit 110 of FIGS. 3, 5, etc. As shown, the processing unit 110 can include a bus 111, a processor 112, a memory 114, interface(s) 116, an input component 118a, an output component 118b, and a communication interface 118c.

The bus 111 includes one or more components that enable wired and/or wireless communication among the components of the processing unit 110. The bus 111 can couple together two or more components of the inspection system (100), such as via operative coupling, communicative coupling, electronic coupling, and/or electric coupling. The processor 112 includes one or more of a central processing unit, a graphics processing unit, a microprocessor, a controller, a microcontroller, a digital signal processor, a field-programmable gate array, an application-specific integrated circuit, and/or another type of processing component. The processor 112 is implemented in hardware, firmware, or a combination of hardware and software. In some implementations, the processor 112 includes one or more processors capable of being programmed to perform one or more operations or processes described elsewhere herein.

The memory 114 includes volatile and/or nonvolatile memory. For example, the memory 114 can include random access memory (RAM), read only memory (ROM), a hard disk drive, and/or another type of memory (e.g., a flash memory, a magnetic memory, and/or an optical memory). The memory 114 can include internal memory (e.g., RAM, ROM, or a hard disk drive) and/or removable memory (e.g., removable via a universal serial bus connection). The memory 114 can be a non-transitory computer-readable medium. In some implementations, the memory 114 includes one or more memories that are coupled to one or more processors (e.g., the processor 112), such as via the bus 111.

The memory 114 stores information, instructions, and/or software 120 (e.g., one or more software applications) related to the operation of the processing unit 110. The software 120 can include a scanning module 122 to control and perform a scan of a sucker rod component (20), a geometric module 124 for calculating geometric information of the sucker rod component (20) from the scan, and an evaluation module 126 for evaluating the sucker rod component (20) based on the geometric information to determine whether to accept or rejection the sucker rod component (20) for service.

The input component 118a enables the processing unit 110 to receive input, such as user input and/or sensed input. For example, the input component 118a can include a touch screen, a keyboard, a keypad, a mouse, a button, a microphone, a switch, a sensor, an accelerometer, a gyroscope, and/or an actuator. The output component 118b enables the processing unit 110 to provide output, such as via a display, a speaker, and/or a light-emitting diode. The communication interface 118c enables the processing unit 110 to communicate with other devices via a wired connection and/or a wireless connection. For example, the communication interface 118c can include a receiver, a transmitter, a transceiver, a modem, a network interface card, and/or an antenna.

The processing unit 110 can perform one or more operations or processes described herein. For example, a non-transitory computer-readable medium (e.g., the memory 114) can store a set of instructions (e.g., one or more instructions or code) in the software 120 for execution by the processor 112. The processor 112 can execute the set of instructions to perform one or more operations or processes described herein. In some implementations, execution of the set of instructions, by one or more processors 112, causes the one or more processors 112 and/or the processing unit 110 to perform one or more operations or processes described herein. In some implementations, hardwired circuitry can be used instead of or in combination with the instructions to perform one or more operations or processes described herein. Additionally, or alternatively, the processor 112 can be configured to perform one or more operations or processes described herein. Thus, implementations described herein are not limited to any specific combination of hardware circuitry and software.

For instance, the memory 114 stores surface profiles 115a associated with sucker rod components (20) to be inspected, and the memory 114 stores geometric limits associated with the sucker rod components (20). These stored surface profile(s) 115a define what geometric parameters (e.g., one or more of the shape(s), dimension(s), contour(s), angle(s), outline(s), etc.) that the given surfaces and features of the sucker rod component (20) are expected to have to meet inspection. The geometric parameters of these stored surface profile(s) 115a are associated with specific geometric limits 115b (e.g., tolerances, ranges, etc.), which define if (and to what extent) a given discontinuity in the sucker rod component (20) between the generated geometric profile 115c with the stored surface profile 115a fails inspection.

Different types of discontinuities (e.g., defects, pits, cracks, etc.) can have different geometric limits as to location, orientation, size, tolerances, or other dimensions. For instance, a pit in the surface of a sucker rod may have a limit of 0.004 inches in a transverse direction of the sucker rod, 0.020 inches in a longitudinal direction, and 0.008 inches in depth into the surface. Should a detected pin in a sucker rod exceed these limits, then the sucker rod could be rejected for service or re-classified to different classes with reduced loading requirements. Other types of defects, such as cracks and the like, can also have limits to meet stringent quality standards for defect detection.

Using the interfaces 116, the processing unit 110 interfaces with one or more scanning units 150 having emitter(s) 152 and detector(s) 154. The emitter(s) 152 are configured to emit electromagnetic radiation onto one or more surfaces of the sucker rod components (20). The detector(s) 154 are associated with the emitter(s) 152. From the emitted electromagnetic radiation incident onto the one or more surfaces, the detector(s) 154 are configured to detect electromagnetic radiation reflected from the one or more surfaces of the sucker rod components (20).

Using the scanning module 122 of the software 120, the processor 112 performs the scan of the sucker rod component (20) using the scanning unit(s) 150. In the scan, the sucker rod component (20), and/or the scanning unit(s) 150 are moved. Using the geometric module 124, the processor 112 generates one or more geometric profiles 115c of the one or more surfaces of the sucker rod component (20) based on the reflected electromagnetic radiation detected with the detector(s) 154. The generated geometric profiles 115c can be stored in memory 114. Using the evaluation module 126, the processor 112 then determines any discontinuity between the generated geometric profile(s) 115c and the stored surface profile(s) 115a, measures one or more geometric parameters (size, length, width, depth, etc.) associated with any of the discontinuities, and compares the geometric parameter(s) to geometric limit(s) 115b. Ultimately, the processor 112 decides to reject or accept the sucker rod components (20) based on the comparison.

The number and arrangement of components shown in FIG. 8 are provided as an example. The processing unit 110 can include additional components, fewer components, different components, or differently arranged components than those shown in FIG. 8. Additionally, or alternatively, a set of components (e.g., one or more components) of the processing unit 110 can perform one or more functions described as being performed by another set of components of the processing unit 110.

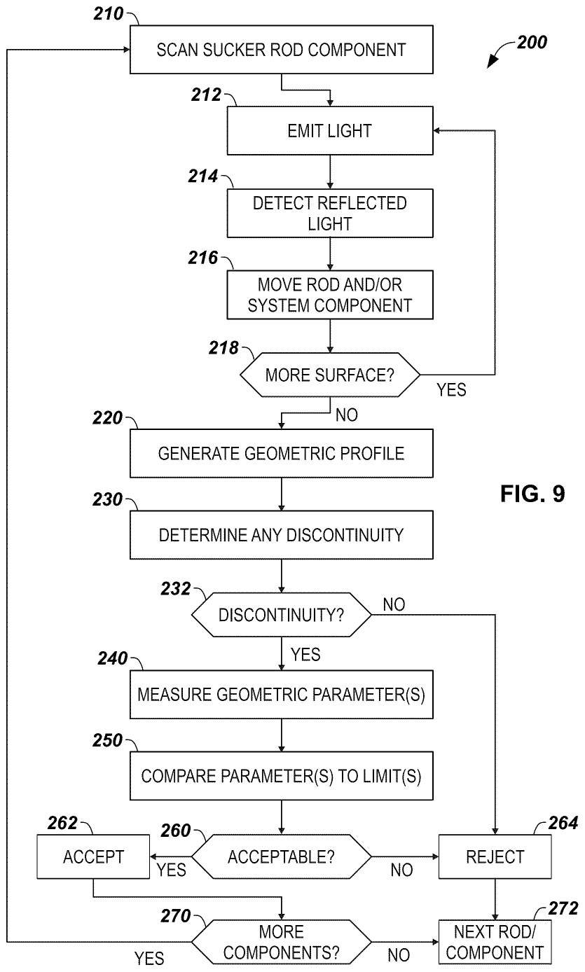

FIG. 9 illustrates a scanning inspection process 200 according to the present disclosure. The scanning inspection process 200 can be performed by features of the inspection system (100) disclosed herein. Accordingly, reference to element numerals used in other drawings are repeated here for better explanation. As noted above, the inspection system 100 can inspect the sucker rod components 20 when the sucker rods 30 are assembled and can inspect used sucker rods 30 to be reused after cleaning, refurbishing, and inspection. Additionally, the inspection system 100 can inspect one or more sucker rod components 20 on each sucker rod 30 or can inspect individual sucker rod components 20 before assemblage on sucker rods.

In the scanning inspection process 200, one or more surfaces of the sucker rod component 20 are scanned using one or more emitters 152 and one or more detectors 154 in a scan (Block 210). Preferably, the scanning is performed in a controlled environment, such as in a machine, a booth, a chamber, or the like, because ambient light, vibration, and dust can affect accuracy.

The processing unit 110 generates one or more geometric profiles 115c of the one or more surfaces of the sucker rod components 20 based on the scan (Block 220). (As discussed above, FIGS. 4A-4D show schematic representations of a portion of such a geometric profile.) The geometric profile 115c that is generated can be a point cloud or other representation of the scanned surfaces. For instance, each scan can produce a cloud of 3D points. The point clouds from different angles can be aligned using registration algorithms (e.g., Iterative Closest Point or using reference markers). Post-processing may be necessary on the electromagnetic radiation signals detected by the detectors 154 and processed by the processing unit 110. For example, noise filtering and outlier removal may be needed. In further post processing, the geometric profile of the sucker rod component 20 can be reconstructed using meshing, triangulation, and the like. Computer-Aided Design (CAD) modeling can also be used to create digital representations.

The processing unit 110 determines if there is any discontinuity between the one or more generated geometric profiles 115c and the one or more stored surface profiles 115a stored in memory (Block 210). As noted above, these stored surface profile(s) 115a define what geometric parameters (e.g., one or more of the shape(s), dimension(s), contour(s), angle(s), outline(s), etc.) that the given surfaces and features of the sucker rod component 20 are expected to pass inspection for service. The geometric parameters of these stored surface profile(s) 115a are associated with specific geometric limits 115b (e.g., tolerances, ranges, etc.), which define if (and to what extent) a given discontinuity between the generated geometric profile 115c and the stored surface profile 115a fails to pass inspection.

If there is not a determined discontinuity (No at 232), then the processing unit 110 generates a positive assessment of the sucker rod component 20 (Block 262). For example, the sucker rod component 20 may be deemed to have passed inspection and may be accepted. If there is a determined discontinuity (Yes at 232), the processing unit 110 measures one or more geometric parameters associated with the discontinuity (Block 240) and compares the one or more geometric parameters to one or more geometric limits 115b (Block 250). Ultimately at Decision 260, the processing unit 110 assesses the sucker rod component 20. For example, the processing unit 110 may either accept (262) or reject (264) the sucker rod component 20 based on the comparison. If the sucker rod component 20 is rejected (264), the process 200 may proceed to the next sucker rod or independent component to the inspected. In accepting the sucker rod component 20 (262), the assessment can indicate a quality or some other characterization of the sucker rod component 20.

The process 200 can proceed to the next component on the subject sucker rod (Decision 270) if more sucker rod components 20 are to be inspected. In that case, the handling unit 130 may move the subject sucker rod and/or the scanning unit 150 may be moved to scan the next sucker rod component on the subject sucker rod to repeat the process 200. Once all of the sucker rod components have been inspected on the subject sucker rod, the assessment can provide a comprehensive assessment, quality value, or other characterization of the subject sucker rod. Once all the sucker rod components 20 have been inspected on the subject sucker rod, the process 200 can move on to the next sucker rod to be inspected (272).

In general, the scanning process (Block 210) involves: emitting electromagnetic radiation from the one or more emitters 152 onto one or more surfaces of the sucker rod components 20 (Block 212); and detecting, with one or more detectors 154, emitted electromagnetic radiation incident onto the one or more surfaces of the sucker rod components 20 and reflected back to the one or more detectors 154 (Block 214). During the scanning or at intervals, the sucker rod component 20 and the one or more emitters 152 can be moved relative to one another (Block 216).

For the scanning process (Block 210), the scan resolution and coverage parameters are defined and can depend on the particular sucker rod component 20 under inspection. The emitter 152 projects electromatic radiation (e.g., light) onto the sucker rod component 20. The detector 154 detects signals after interaction of the emitted electromatic radiation with the surfaces of the sucker rod component 20. For example, reflected light is detected, images of the reflected light are captured, and/or other characteristics (phase shift, time of flight, patterns, etc.) are detected. Certain distance/angle information is known for the emitter 152 and the detector 154, and geometric information for the surfaces of the sucker rod component 20 is calculated. The scanning unit 150 is moved/rotated (and/or the sucker rod component 20 is moved/rotated) to scan additional surface area. Multiple scans may be taken from different perspectives, and the multiple scans can be combined to make a geometric profile of the sucker rod component 20.

Different scanning processes can be used for the scan (Block 210), including laser scanning, photogrammetry, and structured light scanning. The technique used in the scanning process can be governed by the resolution needed for the specific sucker rod component 20 under inspection. Some sucker rod components 20 may require less resolution than other components for a particular discrepancy to be adequately detected for the purposes of inspection noted herein. Additionally, the scanning process used may be suited to the speed and the range at which the inspection is to be performed.

In the laser scanning, for example, the emitter 152 emits laser light for the scan, and the detector 154 detects signals of the laser light reflected from the one or more surfaces. The one or more geometric profiles 115c of the one or more surfaces are then generated by constructing digital coordinates from the detected signals. For example, the emitter 152 can project a laser beam onto the surface of the sucker rod component 20. The detector 154 then detects the reflected laser light, such as by capturing images of the projected laser beam on the surface of the sucker rod component 20. The inspection system 100 can rotate/position either one or both of the sucker rod component 20 and the emitters/detectors of the scanning unit 150 to scan different surfaces of the sucker rod component 20 at different angles. The scanning module 122 performs data acquisition and converts the detected signals of the reflected light into digital 3D coordinates. The geometric module 124 then processes the point clouds into meshes or CAD models so the evaluation module 126 can then assess the sucker rod component 20 (e.g., determine whether to accept or reject the sucker rod component 20 for service).

Generation of the geometric profile 115c of the sucker rod component 20 is based on the laser scanning technology used. The geometric profile 115c captures the shape of the sucker rod component 20 and can include a point cloud, namely a dense set of XYZ coordinates representing the surface geometry. The laser scanning used can include Time-of-Flight (ToF) laser scanning, phase-shift laser scanning, and triangulation-based laser scanning.

Time-of-Flight (ToF) scanning measures the time it takes for a laser pulse to travel to the object and back is measured. The emitter 152 can be a pulsed laser that emits laser light in short pulses. In detecting the signals, the detector 154 records the time taken for the light pulses to reflect from the surface. To convert the detected signals into the digital coordinates, the processing unit 110 calculates distances for the digital coordinates based on the time-of-flight measurements. The inspection system 100 rotates and/or moves either one or both of the sucker rod component 20 and the scanning unit 150 to collect data over a larger surface area.

In phase-shift laser scanning, the emitter 152 is a continuous wave laser, which emits continuous wave laser light in emitted waves of modulated intensity. When detecting the signals, the detector 154 receives reflected light waves, and the processing unit 110 compares the phase shift between the emitted and reflected signals to calculate distances for digital coordinates. The phase-shift laser scanning can be more accurate and faster than ToF and is suited for shorter ranges.

Triangulation laser scanning is based on geometry and calculates distance using known offsets (angles and baseline distances). For the triangulation laser scanning, the emitter 152 projects a laser light object (e.g., a laser line, a laser spot, etc.), from a source position onto the surfaces of the sucker rod component. In detecting the signals, the detector 154 captures images of the projected laser light object (laser line, spot, etc.) on the surfaces. For example, the detector 154 can be a camera to capture images. The detector 154 is in a detection position at a known offset (angle and distance) from the source position of the emitter 152. Converting the captured images into the digital coordinates then involves triangulating the digital coordinates from the source position, the detection position, and the captured images of the projected laser light object on the surfaces. Using the triangulation between the three positions (emitter position, detector position, and variations of the imaged laser light object on the surface), the software 120 computes the 3D coordinates. This scanning can achieve very high precision (e.g., micron) suited for smaller features of the sucker rod component.

In addition to 3D laser scanning, other forms of optical scanning can be used, including photogrammetry and structured light scanning. As noted, laser scanning measures distances using laser light (ToF, phase-shift, or triangulation) so a dense, accurate 3D point cloud can be generated. Photogrammetry uses 2D images from multiple angles to reconstruct 3D geometry via triangulation. A point cloud or 3D mesh (from image features) is then generated.

In structured light scanning, for example, a coded pattern (e.g., grids, stripes, sinusoidal fringes, or the like) of structured light are projected on the surfaces of the sucker rod component 20 by the emitter(s) 152. Detector(s) 154 (e.g., cameras) capture deformation of the light patterns projected on the component's surfaces, and the software 120 reconstructs 3D geometry from the pattern shift by using phase shifting or Gray-code decoding. Distortions are analyzed to infer depth, contour, etc. For example, variations in the surface distort the laser light object projected on the surface, such as how surface height or depth, produce distortions of the coded pattern of the structure light. The images show these distortions, and a high-density 3D point cloud or mesh can be generated for evaluation.

In photogrammetry, for example, multiple overlapping images are captured using the scanning unit(s) 150. The overlapping images are processed in the software 120 using Structure from Motion (SfM) and Multi-View Stereo (MVS) to align the images, produce dense cloud, generate a mesh, and produce texture mapping.

Which form of scanning process (Block 210) to use can be based on a number of factors, such as the accuracy and resolution required to detect any discontinuity that renders the sucker rod component 20 unacceptable for service. The size of the sucker rod component 20 to be evaluated is also a factor. Laser scanning has high accuracy for details at the sub-millimeter to millimeter level. Photogrammetry has medium to high accuracy, which depends on image quality and camera calibration. Structured light scanning has very high accuracy for details at the sub-millimeter level. When implemented in a facility, the inspection system 100 can use laser scanning or structured light scanning, which are less portable and require low lighting. When used in the field, the inspection system 100 can use photogrammetry, which is more portable.

As will be evident from the present disclosure, the inspection system 100 disclosed herein enables sucker rod manufacturers and refurbishers to meet stringent quality standards for defect detection (e.g., 0.004 inches in transverse size, 0.020 inches in longitudinal size, 0.008 inches in depth for a pit on a sucker rod). Information from the inspection system 100 provides field operators with a reliable method to assess sucker rods for fatigue risk and operational safety before deployment. The inspection system 100 also streamlines quality control processes across high-volume production environments while reducing inspection costs.

Moreover, information from the inspection system 100 can support data-driven decisions for improving sucker rod designs, mitigating failures, and optimizing lifting costs in oilfield operations. For instance, information from the inspection system 100 can be used to research defects from the manufacture and use of sucker rod components 20 to find out what conditions have caused the defects. Likewise, information from the inspection system 100 can diagnose the wear performance of sucker rod guides 50 and give insights into string design strategies to improve performance efficiency. Also, information from the inspection system 100 can be used to assess the downhole performance of the sucker rod guide and to evaluate the remaining wear life of the sucker rod guide.

The inspection system 100 works seamlessly for both steel and composite sucker rods, addressing limitations in inspecting non-ferromagnetic materials. In a streamlined process, the inspection system 100 eliminates the magnetization, demagnetization, and calibration steps required by traditional methods, reducing time, complexity, and operational costs. High-speed inspection allows operators to process larger volumes of sucker rods in less time, reducing bottlenecks and increasing throughput. Automated and objective inspection ensures consistent results, minimizing human error and variability associated with manual techniques. By reducing maintenance, consumable usage, and downtime, the solution significantly cuts operational costs over time. Early detection of defects prevents failures, reducing the frequency of expensive repairs, replacements, and operational downtime.

As used herein, the term “rod” and “sucker rod” can include hollow or solid rods, continuous rods, joints, or the like. The term “rod” can include welded, flanged, screwed, and other rod goods. In particular, joints of sucker rods used in artificial rod lift systems are one type of rod that can benefit from the techniques described herein, but the disclosure is not so limited. As used herein, the term “rod” and “sucker rod” can mean a rod that has been in actual service in the filed for a purpose, such as lifting fluids by connecting a downhole pump to a surface driver. Likewise, the term “rod” and “sucker rod” can mean a rod that has been manufactured in a facility or can mean a rod that has been previously used but has been remanufactured, reconditioned, or repaired for use again in the field.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A method used on a plurality of sucker rods, each sucker rod having a sucker rod component to be inspected, the method comprising:
storing, in memory, a surface profile associated with the sucker rod component; and
storing, in the memory, a geometric limit associated with the sucker rod component;
wherein for the sucker rod component to be inspected on each of the sucker rods, the method comprises:
scanning, in a scan using at least one emitter and at least one detector, a surface of the sucker rod component;
generating, with at least one processor, a geometric profile of the surface of the sucker rod component based on the scan;
determining, with the at least one processor, any discontinuity between the geometric profile and the surface profile;
measuring, with the at least one processor, a geometric parameter associated with the any discontinuity;
comparing, in a comparison with the at least one processor, the geometric parameter to the geometric limit; and
generating, with the at least one processor, an assessment of the sucker rod component based on the comparison.

2. The method of claim 1, wherein scanning, in the scan using the at least one emitter and the at least one detector, the surface of the sucker rod component comprises:
emitting electromagnetic radiation from the at least one emitter onto the surface of the sucker rod component; and
detecting, with the at least one detector, a signal after interaction of the emitted electromagnetic radiation with the surface of the sucker rod component.

3. The method of claim 2, wherein emitting the electromagnetic radiation comprises emitting a coded pattern of structured light in structured light scanning for the scan; wherein detecting the signals comprises capturing an image of the structured light patterned on the surface; and wherein generating the geometric profile of the surface comprises constructing digital coordinates for the geometric profile of the surface based on deformation of the coded pattern in the image.

4. The method of claim 2, wherein emitting the electromagnetic radiation comprises emitting laser light in laser scanning for the scan; wherein detecting the signal comprises detecting reflected laser light from the surface of the sucker rod component; and wherein generating the geometric profile of the surface comprises constructing digital coordinates for the geometric profile based on the detected laser light.

5. The method of claim 4, wherein emitting the laser light comprises emitting the laser light in pulses; wherein detecting the reflected laser light comprises detecting time-of-flight measurements of the pulses; and wherein constructing the digital coordinates based on the detected laser light comprises calculating the digital coordinates based on the time-of-flight measurements.

6. The method of claim 4, wherein emitting the laser light comprises emitting continuous wave laser light in emitted waves of modulated intensity; wherein detecting the reflected laser light comprises detecting reflected waves from the surface; and wherein constructing the digital coordinates based on the detected laser light comprises calculating the digital coordinates based on a phase difference between the emitted waves and the reflected waves.

7. The method of claim 4, wherein emitting the laser light comprises projecting a laser light object from a source position onto the surface; wherein detecting the signal comprises capturing an image of the projected laser light object from a detection position, the detection position being at a known offset from the source position; and wherein constructing the digital coordinates based on the detected laser light comprises triangulating the digital coordinates from the source position, the detection position, and the captured image of the projected laser light object on the surface.

8. The method of claim 1, wherein scanning the surface of the sucker rod component in the scan comprises moving the sucker rod component and a scanning component relative to one another, the scanning component including at least one of the at least one emitter and the at least one detector.

9. The method of claim 8, wherein moving the sucker rod component and the scanning component relative to one another comprises at least one of:
moving the sucker rod component relative to the scanning component;
moving the scanning component relative to the sucker rod component; and
moving the sucker rod component in an axial direction;
rotating the sucker rod component about an axis;
moving the scanning component in the axial direction; and
rotating the scanning component about the axis.

10. The method of claim 1, wherein determining the any discontinuity between the geometric profile and the surface profile comprises determining at least one of a defect, a crack, a microcrack, a pit, a cross-sectional area loss, and a dimensional variation as the any discontinuity.

11. The method of claim 1, wherein measuring the geometric parameter associated with the any discontinuity comprises measuring one or more of a dimension, a length, a depth, a width, an area, and a volume of the any discontinuity.

12. The method of claim 1, wherein scanning the surface of the sucker rod component comprises scanning the surface of at least one of a rod end the sucker rod, a pin thread on the rod end, a flat on the rod end, a shoulder on the rod end, a forged upset on the rod end, a rod body of the sucker rod, a metal rod body of the sucker rod, a composite rod body of the sucker rod, and a metal end fitting on the composite rod body.

13. The method of claim 1, wherein generating the assessment of the sucker rod component based on the comparison comprises outputting at least one of an acceptance and a rejection of the sucker rod component.

14. A method used on a plurality of sucker rods, each sucker rod having a plurality of sucker rod components to be inspected, the method comprising:
storing, in memory, surface profiles, each of the surface profiles being associated with a respective one of the sucker rod components; and
storing, in the memory, geometric limits, each of the geometric limits being associated with a respective one the sucker rod components,
wherein for each given one of the sucker rod components of the plurality of sucker rod components to be inspected on each given one of the sucker rods, the method comprises:
scanning, in a scan using at least one emitter and at least one detector, a surface of the given sucker rod component on the given sucker rod;
generating, with at least one processor, a geometric profile of the surface of the given sucker rod component based on the scan;
determining, with the at least one processor, any discontinuity between the geometric profile and the surface profile associated with the given sucker rod component;
measuring, with the at least one processor, a geometric parameter associated with the any discontinuity;
comparing, in a comparison with the at least one processor, the geometric parameter to the geometric limit associated with the given sucker rod component; and
generating, with the at least one processor, an assessment of the given sucker rod component based on the comparison.

15. The method of claim 14, wherein for each given sucker rod, the method further comprises generating, with the at least one processor, a comprehensive assessment of the given sucker rod based on the assessments for each of the given sucker rod components of the given sucker rod.

16. A system used on a plurality of sucker rods, each sucker rod having a given sucker rod component to be inspected, the system comprising:
memory storing a surface profile associated with the given sucker rod component and storing a geometric limit associated with the given sucker rod component;
at least one emitter configured to emit electromagnetic radiation onto a surface of the given sucker rod component;
at least one detector being configured to detect signals after interaction of the emitted electromagnetic radiation with the surface of the given sucker rod component; and
at least one processor in operable communication with the memory, the at least one emitter, and the at least one detector, wherein for the sucker rod component to be inspected on each of the sucker rods, the at least one processor is configured to:
scan the surface of the given sucker rod component in a scan using the at least one emitter and the at least one detector;
generate a geometric profile of the surface of the given sucker rod component based on the scan;
determine any discontinuity between the geometric profile and the surface profile;
measure a geometric parameter associated with the any discontinuity;
compare the geometric parameter in a comparison to the geometric limit; and
generate an assessment of the given sucker rod component based on the comparison.

17-21. (canceled)

22. The system of claim 16, further comprising a handling unit being configured to move each of the sucker rods and a scanning component relative to one another, the scanning component including at least one of the at least one emitter and the at least one detector.

23. The system of claim 22, wherein to move the sucker rod component and the scanning component, the handling unit is configured to at least one of:
move the sucker rod component relative to the scanning component;
move the scanning component relative to the sucker rod component; and
move the sucker rod component in an axial direction;
rotate the sucker rod component about an axis;
move the scanning component in the axial direction; and
rotate the scanning component about the axis.

24-26. (canceled)

27. The system of claim 16, wherein:
the memory stores a plurality of surface profiles in addition to the surface profile associated with the given sucker rod component, each of the surface profiles being associated with a respective one of a plurality of sucker rod components in addition to the given surface rod component;
the memory stores a plurality of geometric limits, each of the geometric limits being associated with a respective one the sucker rod components; and
for each of the sucker rod components of the plurality of sucker rod components to be inspected on each one of the sucker rods, the at least one processor is configured to:
scan the surface of the each sucker rod component in the scan using the at least one emitter and the at least one detector;
generate the geometric profile of the surface of the each sucker rod component based on the scan;
determine the any discontinuity between the geometric profile and the surface profile;
measure the geometric parameter associated with the any discontinuity;
compare the geometric parameter in the comparison to the geometric limit; and
generate the assessment of the each sucker rod component based on the comparison.

28. The system of claim 27, wherein for each of the sucker rods, the at least one processor is further configured to generate a comprehensive assembly of the each sucker rod based on the assessments for each of the sucker rod components of the each sucker rod.
